(19) United States
(12) Patent Application Publication
(10) Pub. No.: US 2026/0059467 A1
(43) Pub. Date: Feb. 26, 2026

(54) TECHNIQUES FOR CHANGING NETWORK SLICES FOR PROTOCOL DATA UNIT SESSIONS

(71) Applicant: Lenovo (Singapore) Pte. Limited, Singapore (SG)

(72) Inventors: Genadi Velev, Darmstadt (DE); Apostolis Salkintzis, Glika Nera (GR); Dimitrios Karampatsis, Ruislip (GB)

(73) Assignee: Lenovo (Singapore) Pte. Limited, Singapore (SG)

(21) Appl. No.: 19/101,856

(22) PCT Filed: Sep. 28, 2022
(86) PCT No.: PCT/EP2022/077063

§ 371 Date: Feb. 6, 2025

(30) Foreign Application Priority Data
Aug. 8, 2022 (GR) 20220100662

(51) Int. Cl. H04W 60/00; H04L 69/322

(52) U.S. Cl. CPC H04W 60/002; H04L 69/322

(57) ABSTRACT

Various aspects of the present disclosure relate to changing network slices for a protocol data unit (PDU) sessions. An apparatus receives a first signaling as a registration request from a user equipment (UE) to register with a first network slice, and the apparatus transmits a second signaling indicating acceptance of the registration and an allowability of the UE to register with an alternative network slice. The UE transmits the first signaling to request a registration with the first network slice, and receives the second signaling indicating the registration with the first network slice and an allowability to register with the alternative network slice. The UE transmits a third signaling to establish a first PDU session on the first network slice.

### TECHNICAL FIELD

The present disclosure relates to wireless communications, and more specifically to changing (e.g., switching, updating, modifying) a network slice.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Network slicing enables a network operator to divide a network into granular “slices” to provide customized network connectivity or features for customer devices and/or external service providers. A network slice is a logical network that has a set of network functions and corresponding resources (e.g., computing, storage, networking) to provide certain network capabilities and network characteristics. A network slice can include the core network control plane and user plane network functions, as well as an access network (e.g., 5G radio access network or fixed access network). A UE can be configured with network slice relevant information, which is network slice selection assistance information (NSSAI), which may include single or multiple S-NSSAIs (single NSSAIs).

### SUMMARY

The present disclosure relates to methods, apparatuses, and systems that support techniques for changing network slices for protocol data unit (PDU) sessions. By utilizing the described techniques, a network entity determines, in the network, an alternative network slice (e.g., a second network slice S-NSSAI-2) to a first network slice (e.g., S-NSSAI-1), and configures a UE correspondingly to use the alternative network slice S-NSSAI (e.g., S-NSSAI-2) for PDU session establishment. In implementations, the network entity that determines the alternative network slice is one or more of an access and mobility management function (AMF), a network slice selection function (NSSF), and/or a policy control function (PCF).

Aspects of the disclosure are directed to the AMF indicating to a UE during a registration procedure whether the network supports an alternative slice (S-NSSAI) feature and/or whether the UE is allowed to request an alternative S-NSSAI. The AMF can also indicate to a session management function (SMF) that the PDU session is be established on an alternative S-NSSAI. The SMF sends a PDU session release (or modification) message to the UE, including a new 5GSM cause value to indicate to the UE that re-establishment on an alternative S-NSSAI is intended. If there are (a) no route selection descriptors (RSDs) with S-NSSAI different from S-NSSAI-1, or (b)S-NSSAIs from other RSDs are in rejected NSSAI, then the UE sends a registration request for an unknown network slice which is intended to be an alternative to a subscribed S-NSSAI (e.g., an alternative to S-NSSAI-1, where the alternative network slice is assumed to be S-NSSAI-2).

By performing aspects of the described techniques for changing network slices for PDU sessions, a UE determines or finds an alternative S-NSSAI according to the one or more UE route selection policy (URSP) rules. If no alternative S-NSSAI is available in the URSP rule, then a new S-NSSAI is determined in the AMF, after the UE has requested an alternative S-NSSAI from the AMF. Further, the AMF is able to inform the UE about the need to establish the PDU session on an alternative (or compatible)S-NSSAI without requiring the session management (SM) (sub-) layer to be engaged. An alternative network slice S-NSSAI is compatible if determined usable to establish a PDU session for the UE.

In some implementations of the method and apparatuses described herein, a UE transmits a first signaling to request registration with a first network slice, and receives a second signaling indicating the registration with the first network slice and an allowability to register with an alternative network slice. The UE transmits a third signaling to establish a first PDU session on the first network slice.

Some implementations of the method and apparatuses described herein may further include the UE identifies an absence of the alternative network slice in configured network slice selection assistance information (NSSAI). The UE transmits a fourth signaling indicating that the UE supports a capability to register with the alternative network slice. The UE receives a fourth signaling indicating to re-establish the first PDU session on the alternative network slice based at least in part on an unavailability of the first network slice, and transmits a fifth signaling to request a registration with the alternative network slice based on an inability to identify the alternative network slice. The UE receives a sixth signaling indicating an acceptance of the registration and configured NSSAI including an identity of the alternative network slice, the alternative network slice mapped to the first network slice, and initiates to establish a second PDU session on the alternative network slice, the second PDU session using a same route selection descriptor as the first PDU session based on the alternative network slice mapped to the first network slice. The UE transmits the fifth signaling to request the registration with the alternative network slice based on a determination that there is not an identified alternative network slice for re-establishing the first PDU session.

In some implementations of the method and apparatuses described herein, an AMF (or a network device that implements an AMF) receives a first signaling as a registration request from a UE to register with a first network slice, and transmits a second signaling indicating acceptance of the registration and an allowability of the UE to register with an alternative network slice.

Some implementations of the method and apparatuses described herein may further include the AMF identifies an absence of the alternative network slice in configured NSSAI. The AMF receives a third signaling from the UE indicating that the UE supports a capability to register with the alternative network slice. The AMF transmits a third signaling to a network function serving a first PDU session that is established on the first network slice, the third signaling including an indication that the first PDU session can be established on an alternative network slice. The AMF receives a third signaling as an additional registration request from the UE to register with the alternative network slice based on an inability of the UE to identify the alternative network slice in response to the UE having been signaled to re-establish a first PDU session. The AMF transmits a fourth signaling to the UE indicating an acceptance of the registration and configured NSSAI including an identity of the alternative network slice, the alternative network slice mapped to the first network slice, and receive a fifth signaling indicating the UE has established a second PDU session using a same route selection descriptor as the first PDU session based on the alternative network slice mapped to the first network slice. If the UE is non-roaming, the alternative network slice is mapped to the first network slice based on the NSSAI. If the UE is roaming, the alternative network slice is mapped to the first network slice based on a home public land mobile network (HPLMN) NSSAI.

### BRIEF DESCRIPTION OF THE DRAWINGS

FIG. 1 illustrates an example of a wireless communications system that supports techniques for changing network slices for PDU sessions in accordance with aspects of the present disclosure.

FIG. 2 illustrates an example 5GS architecture for a UE associated with two network slices, which supports techniques for changing network slices for PDU sessions in accordance with aspects of the present disclosure.

FIG. 3 illustrates an example of a signaling flow diagram for a UE to (re-) establish a current PDU session from a first network slice to an alternative, second network slice, which supports techniques for changing network slices for PDU sessions in accordance with aspects of the present disclosure.

FIG. 4 illustrates an example of a signaling flow diagram for a UE to establish a new PDU session on a first, unavailable network slice, where an AMF determines to use an alternative, second network slice, which supports techniques for changing network slices for PDU sessions in accordance with aspects of the present disclosure.

FIGS. 5 and 6 illustrate an example of a block diagram of devices that supports techniques for changing network slices for PDU sessions in accordance with aspects of the present disclosure.

FIGS. 7 through 10 illustrate flowcharts of methods that support techniques for changing network slices for PDU sessions in accordance with aspects of the present disclosure.

### DETAILED DESCRIPTION

A network operator can divide a network into network slices to provide customized network connectivity or features for customer devices and/or external service providers. A network slice is a logical network with a set of network functions and corresponding resources (e.g., computing, storage, networking) to provide certain network capabilities and network characteristics. A network slice can include the core network control plane and user plane network functions, as well as an access network. A UE can be configured with network slice configuration information, NSSAI, which may include single or multiple S-NSSAIs (single NSSAIs).

A network slice that is being used by a UE may be changed to another network slice (e.g., slice remapping), such as during UE mobility due to a lack of support of a first network slice in the target cell, or due to resource limitations of the first network slice in the target radio access network (RAN) node. However the drawback of conventional techniques is that slice remapping is performed transparently to the UE non-access stratum (NAS) layer, or even transparent to the UE access stratum (AS) layer. The slice remapping is performed in the RAN side without altering the UE NAS layer or 5G core network (5GCN or 5GC). However, a change of the network slice will change the UE because the UE needs to be reconfigured with the alternate network slice, which is exchanged for the first network slice. Another conventional technique suggests that the SMF communicates the alternative network slice to the UE in the NAS session management (SM) signaling. However, this does not account for how the UE would process an alternative network slice for different PDU sessions on a previous network slice.

In aspects of the described techniques for techniques for changing network slices for PDU sessions, a network entity (e.g., AMF) determines an alternative network slice (S-NSSAI-2) to a first network slice (e.g., S-NSSAI-1), and configures a UE correspondingly to use the alternative S-NSSAI (e.g., S-NSSAI-2) for PDU session establishment. Aspects of the disclosure are directed to the AMF indicating to a UE during a registration procedure whether the network supports an alternative network slice feature and/or whether the UE is allowed to request an alternative network slice. The AMF can also indicate to a SMF that the PDU session is be established on an alternative network slice. The SMF sends a PDU session release (or modification) message to the UE, including a new 5GSM cause value to indicate to the UE that re-establishment on an alternative network slice is intended. If there are no RSDs with a network slice different than the first network slice that is in use, or (b) network slices from other RSDs are in rejected NSSAI, then the UE sends a registration request for an unknown network slice which is intended to be an alternative to a subscribed network slice (e.g., an alternative to the first network slice, where the alternative network slice is assumed to be a second network slice.

By performing aspects of the described techniques for changing network slices for PDU sessions, a UE determines or finds an alternative S-NSSAI according to the one or more URSP rules. If no alternative S-NSSAI is available in the URSP rule, then a new S-NSSAI is determined in the AMF, after the UE has requested an alternative S-NSSAI from the AMF. Further, the AMF is able to inform the UE about the need to establish the PDU session on an alternative S-NSSAI without requiring the session management (SM) (sub-) layer to be engaged.

Aspects of the present disclosure are described in the context of a wireless communications system. Aspects of the present disclosure are further illustrated and described with reference to device diagrams and flowcharts.

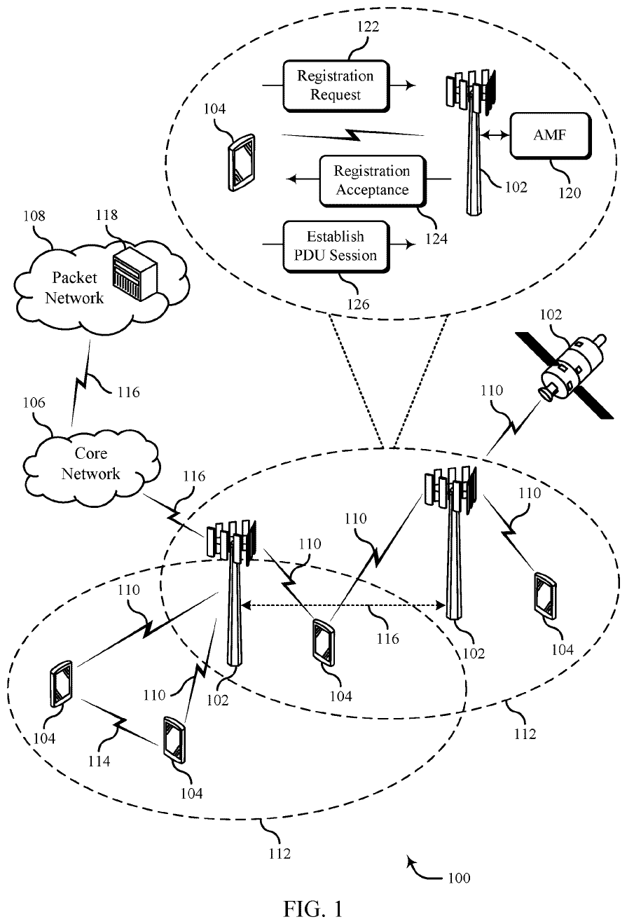

FIG. 1 illustrates an example of a wireless communications system 100 that supports techniques for changing network slices for PDU sessions in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more Ues 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage NAS functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHz-114.25 GHZ), FR4a or FR4-1 (52.6 GHz-71 GHZ), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FRI may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 (to include access network), the UEs 104, an AMF 120, and/or SMFs are operable to implement various aspects of techniques for changing network slices for PDU sessions, as described herein. For instance, the UE 104 transmits a registration request 122 to register with a first network slice, and the AMF 120 (or a network device that implements the AMF) receives the registration request 122 from the UE 104 (via network entity 102) to register with the first network slice. The AMF 120 transmits a registration acceptance response 124 to the UE 104, indicating acceptance of the registration and an allowability of the UE to register with an alternative network slice. The UE 104 receives the registration acceptance response 124 and the indication of allowability to register with an alternative network slice. The UE 104 then transmits to establish a PDU session 126 on the first network slice, which is received by the AMF 120.

Generally, a UE requests registration to network slices by communicating, to the 5GC (e.g., AMF) a NAS registration request message including a requested NSSAI containing a list of one or more S-NSSAIs to which the UE wants to register. The AMF communicates to the UE, in the registration acceptance message or in a UE configuration update command message, one or more elements related to the network slice configuration of the UE, such as allowed NSSAI, configured NSSAI, rejected NSSAI, or pending NSSAI. The NSSAI is a list of one or more S-NSSAIs.

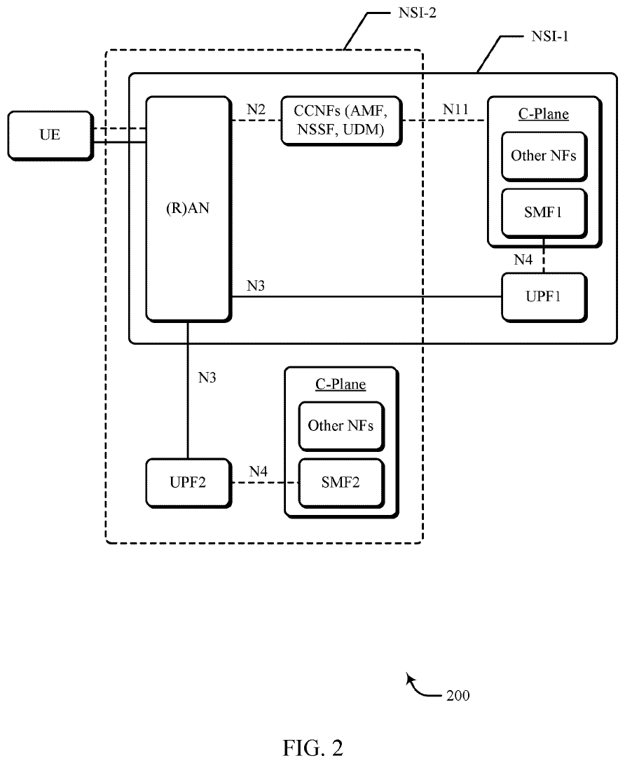

FIG. 2 illustrates an example 5GS architecture 200 for a UE associated with two network slices, which supports techniques for changing network slices for PDU sessions in accordance with aspects of the present disclosure. The UE is associated with two network slices that are deployed correspondingly over a first network slice instance (e.g., “NSI-1” depicted in a solid line) and a second network slice instance (“NSI-2” depicted in dashed line). According to this example architecture 200, the (radio) access network ((R)AN) is part of the two network slices and is shared. The core network of the network slices (or NSIs) has common control plane network functions (CCNFs) and dedicated CN network functions, such as SMF1, user plane function (UPF) 1, and other network functions (NFs) belonging to NSI-1, and SMF2, UPF2, and other NFs belonging to NSI-2. Note that the example 5GS architecture 200 does not show or include all of the network functions (e.g., AMF, NSSF, SMF, UPF, etc.) or all of the reference points.

The support of network slice service continuity during UE mobility due to a lack of support for a network slice, or resource limitations of the network slice in the target RAN node, are considered. These scenarios may occur due to network slices not being required to be available in all tracking areas (TAs) of a network. In aspects of this disclosure, a non-mobility scenario (or event) and a mobility scenario (or event) in the network are taken into consideration, which results in a change of a network slice. For the non-mobility scenario, a network slice (or network slice instance) is overloaded or undergoing planned maintenance in CN (e.g., network slice termination) and/or b) network performance of the network slice cannot meet the service level agreement (SLA) as agreed with the network slice customer, and therefore the UE should use an alternate network slice to fulfil the SLA. The mobility scenario is considered, particularly in the event of inter-registration area (RA) mobility where a network slice (or network slice instance) is overloaded in the target CN.

Aspects of the present disclosure take into account whether a current network slice (or network slice instance) can serve the PDU session, or whether the current network slice instance can meet the performance requirements of the applications. If a possible alternative S-NSSAI is not part of a UE subscribed S-NSSAIs (stored in the UE context in the AMF), then the alternative S-NSSAI is also not part of the UE configured NSSAI and URSP rules. The UE cannot request registration to an alternative S-NSSAI. Aspects of the present disclosure consider allowing the UE to register with an alternative S-NSSAI which is not part of the UE configured NSSAI. Further, aspects of the present disclosure consider how to assure that an alternative S-NSSAI (e.g., S-NSSAI-2) is compatible with the UE network slice configuration and routing policy (e.g., NSSP/URSP, configured NSSAI, and/or allowed NSSAI).

When a network slice that is used by a UE changes to another network slice, this network slice change is referred to as a slice remapping, such as during UE mobility due to a lack of support of a first network slice in the target cell or resource limitations of the first network slice in the target RAN node. However the drawback of conventional techniques is that slice remapping is performed transparently to the UE NAS layer, or even transparent to the UE AS layer. In other words, slice remapping is performed in the RAN side without altering the UE NAS layer or 5G core network (5GCN or 5GC). However, in the above described scenarios, a change of the network slice will change the UE and 5GC because the UE needs to be reconfigured with the alternate network slice, which is exchanged for the first network slice. Another conventional technique suggests that the SMF communicates the alternative S-NSSAI to the UE in the NAS SM signaling. However, this does not account for how the UE would process an alternative S-NSSAI for different PDU sessions on a previous S-NSSAI (e.g., S-NSSAI-1).

In aspects of techniques for changing network slices for PDU sessions, a network operator allows data traffic of an application to be routed over more than a single network slice, and these more than one network slices are part of the UE subscribed S-NSSAIs. It is assumed that the network should have configured the URSP rules in the UE, and that the application data traffic uses one or more RSDs, each including a different S-NSSAI. If a new PDU session is about to be setup, or if a current PDU session is about to be re-established, the UE is prompted to use a RSD that is different from the currently used RSD.

An example of the UE subscription data and configuration with two network slices is:

UE subscription data:

| | |
|---|---|
| - S-NSSAI-1 (default) | (eMBB) |
| - S-NSSAI-2 | (eMBB) |

URSP rule:

- Traffic Descriptor for App1:
= RSD#1: S-NSSAI-1, DNN-1;
= RSD#2: S-NSSAI-2, DNN-1;

where the UE is subscribed with S-NSSAI-1 and S-NSSAI-2, and the UE subscription data is stored in the unified data management (UDM), as well as in the serving AMF when the UE is registered with the network. The network (e.g., PCF) configures a set of URSP rules for the UE, such as shown in the example of a URSP rule for the data traffic of the application, App1. This example URSP rule includes two RSDs: RSD #1 includes the combination of [S-NSSAI-1, data network name (DNN)1] and RSD #2 includes the combination of [S-NSSAI-2, DNN1].

When the UE wants to establish a PDU session using this URSP rule, the UE first checks whether S-NSSAI-1 is part of the allowed NSSAI. If yes, the UE uses the RSD #1 to establish the PDU session. If the S-NSSAI-1 is not part of the allowed NSSAI, the UE checks whether the S-NSSAI-2 is part of the allowed NSSAI. If yes, the UE uses the RSD #2 to establish the PDU session. If neither of the S-NSSAI-1 and S-NSSAI-2 are part of the allowed NSSAI and are in rejected NSSAI, then the UE cannot establish a PDU session with this URSP rule. In aspects of this disclosure, the UE is allowed (i.e. configured by the network) to request a registration to a S-NSSAI which is an alternative to S-NSSAI-1, and the alternative S-NSSAI is not part of the UE configured NSSAI.

There are several possible scenarios regarding the relation of the second network slice (S-NSSAI-2) with the UE subscribed S-NSSAI(s) list stored in the UE subscription data and in the UE context in AMF. Scenario a) the S-NSSAI-2 is part of the subscribed S-NSSAIs and is already part of the allowed NSSAI. Scenario b) the S-NSSAI-2 is part of the subscribed S-NSSAIs, but not part of the allowed NSSAI, and the S-NSSAI-2 can be added to the allowed NSSAI because the S-NSSAI-2 is supported in the current TA. Scenario c) the S-NSSAI-2 is part of the subscribed S-NSSAIs, but not part of the allowed NSSAI, and the S-NSSAI-2 cannot be added to the allowed NSSAI because the S-NSSAI-2 is not supported in the UE's current TA. Scenario d) the S-NSSAI-2 is not part of the subscribed S-NSSAIs, and therefore, not part of the UE configured NSSAI, and the UE cannot request and use S-NSSAI-2 unless the S-NSSAI-2 is not part of the UE configured NSSAI.

Aspects of this disclosure describe how the network slice S-NSSAI-2 can replace the network slice S-NSSAI-1 in the scenarios described above, particularly in the last two scenarios c) and d). In the scenarios a) and b) it is assumed that the alternative S-NSSAI-2, which is pending to replace the S-NSSAI-1, is part of the UE subscribed S-NSSAIs. Therefore, the alternative S-NSSAI-2 would be configured in the UE URSP rule, specifically in the URSP rule which is used to establish the current PDU session(s) on S-NSSAI-1, if the S-NSSAI-2 is allowed to be used for the application data traffic. Hence, there is no need for the SMF to indicate any alternative S-NSSAI-2 to the UE in the NAS SM signaling for PDU session releases. It is sufficient to indicate to the UE that a current PDU session needs to be re-established on a different S-NSSAI and the UE would select to use another RSD with S-NSSAI different from S-NSSAI-1.

Aspects of the disclosure are directed to the AMF indicating to a UE during a registration procedure whether the network supports an alternative slice (S-NSSAI) feature and/or whether the UE is allowed to request an alternative S-NSSAI. The AMF can also indicate to a SMF that the PDU session is be established on an alternative S-NSSAI. The SMF sends a PDU session release (or modification) message to the UE, including a new 5GSM cause value to indicate to the UE that re-establishment on an alternative S-NSSAI is intended. If there are (a) no RSDs with S-NSSAI different from S-NSSAI-1, or (b)S-NSSAIs from other RSDs are in rejected NSSAI, then the UE sends a registration request for an unknown network slice which is intended to be an alternative to a subscribed S-NSSAI (e.g., an alternative to S-NSSAI-1, where the alternative network slice is assumed to be S-NSSAI-2).

As described herein, the term “alternative” S-NSSAI feature (or “compatible” S-NSSAI feature) means functionality supported by the network and UE, where a first S-NSSAI of a PDU session can be exchanged with another (second)S-NSSAI, where the second S-NSSAI may or may not be included in the UE configured NSSAI. In an implementation, the second S-NSSAI is not part of the UE configured NSSAI, and therefore, the network determines and configures the UE. Additionally in the network, a second S-NSSAI replaces the first S-NSSAI (e.g., first S-NSSAI-1 is pending being replaced or exchanged with a second S-NSSAI).

Aspects of the present disclosure include re-establishment of a current PDU session where an alternative S-NSSAI is applicable. Implementations assume that a UE has already established a PDU session, and due to an event, such as described above, the current PDU session (or PDU sessions) has to be transferred from a first network slice (S-NSSAI-1) to a second network slice (S-NSSAI-2).

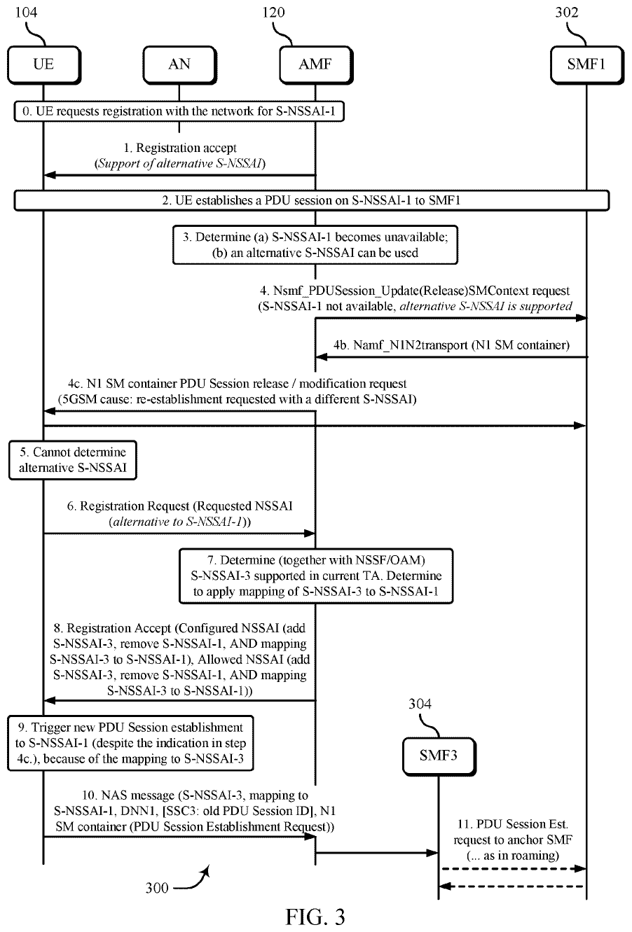

FIG. 3 illustrates an example of a signaling flow diagram 300 that supports techniques for changing network slices for PDU sessions in accordance with aspects of the present disclosure. The example signaling flow diagram 300 illustrates how a UE is triggered to (re-) establish a current PDU session (from a first S-NSSAI) to an alternative second S-NSSAI. The UE (re-) establishes a current PDU session (using a first S-NSSAI-1), and an alternative second S-NSSAI (S-NSSAI-2) is used for a new PDU session.

The UE 104 requests registration with the network (at step 0), specifically to register with a first network slice (e.g. S-NSSAI-1). In the NAS registration request message, the UE can indicate to the AMF 120 its capabilities (e.g., core network capability, 5GMM capabilities). The UE include, in addition a new 5GMM capability, whether the UE supports the feature of requesting an alternative S-NSSAI. This UE capability can be used in the AMF to determine whether to provide the UE with a configuration that allows the UE to request an alternative S-NSSAI.

The AMF sends the UE a registration accept message (at step 1), and the message can include a new indication (e.g. configuration) indicating the UE is allowed to request an alternative S-NSSAI. This new indication from the AMF has the meaning of at least one of: (a) the network supports “alternative” S-NSSAI feature and/or (b) the UE is allowed to use the feature of requesting an “alternative” S-NSSAI. The AMF determines whether to send this new indication to the UE based on the UE 5GMM capability received in step 0, UE subscription data (e.g. whether the UE is a subscriber of a certain organization or enterprise), the type of UE subscribed S-NSSAIs, and/or AMF capability and AMF local configuration. If the AMF does not support the feature of alternative S-NSSAI, or the AMF does not allow the UE to use the feature (e.g. a low-priority UE), then the AMF does not send the indication to the UE. If the UE does not receive an indication that UE is allowed to request alternative S-NSSAI, the UE should not initiate step 6.

The UE initiates (at step 2) the establishment of a PDU session on S-NSSAI-1 to SMF1 302. For example, the UE uses RSD #1 to establish the PDU session (e.g., from the example of the UE subscription data and configuration with two network slices, included above). The AMF determines (at step 3) at least one of: (a)S-NSSAI-1 becomes unavailable and (b) an alternative S-NSSAI can be used to replace S-NSSAI-1. The S-NSSAI-1 may become unavailable due to any one of a non-mobility event (e.g., operation, administration, and maintenance (OAM) or NSSF/NF reconfiguration, or the S-NSSAI-1 will be down due to network maintenance); or a UE mobility event (e.g. the T-AMF does not support S-NSSAI-1). In conventional solutions, the AMF triggers the release of the PDU sessions associated with the S-NSSAI, which is no longer available. In the described techniques, the AMF implements a new feature and determines that the S-NSSAI, which is no longer available, can be replaced with another (e.g., alternative) S-NSSAI.

The AMF sends a request message to the SMF1 (at step 4a) to indicate that the PDU session should be released or modified. The AMF invokes the Nsmf_PDUSession_ReleaseSMContext service operation to request the release of the PDU session. The AMF invokes the Nsmf_PDUSession_UpdateSMContext service operation to request a modification of the PDU session. If the AMF determines that the S-NSSAI-1 is no longer available, but there is an alternative S-NSSAI which can be used for to replace the S-NSSAI-1, then the AMF includes a new indication to the SMF that the alternative S-NSSAI is supported.

The SMF determines to release the PDU session (at step 4b). The PDU session may be of any session and service continuity (SSC) mode (e.g., SSC mode 1, SSC mode 2, or SSC mode 3). Although for PDU sessions in SSC mode 1, the network preserves the connectivity service provided to the UE (i.e., no IP address/prefix change), upon a network event where the change on a network slice is unavoidable, then the SMF can trigger release of the PDU session with a re-establishment cause values described below. For PDU sessions in SSC mode 2 or mode 3, the SMF initiates the PDU session release with the re-establishment cause values described below. Further, the SMF releases the IP address and/or prefix(es) that were allocated to the PDU session and releases the corresponding user plane resources in the UPF using N4 signaling (not shown in the figure).

When the SMF wants to release a PDU session due to congestion or the S-NSSAI is no longer available, in current systems the SMF includes the 5GSM cause value #69 “insufficient resources for specific slice” in the PDU session release command message. In the case of a PDU session of SSC mode 2 when the SMF wants the UE to re-establish the PDU session, the SMF includes 5GSM cause value #39 “reactivation requested”. In aspects of this disclosure, a new 5GSM cause value is specified to indicate to the UE that re-establishment on an “alternative S-NSSAI” is desired. The SMF creates a N1 SM container to be sent to the UE, including a PDU session release command or a PDU session modification request message including the PDU session identity (ID) and 5GSM cause value. The 5GSM cause value indicates a trigger to establish a new PDU session with the same characteristics but with a different S-NSSAI. The SMF invokes the Namf_Communication_N1N2MessageTransfer service operation (N1 SM container, N2 information), whereas the SMF may not include the “skip indicator”. By not including the “skip indicator”, the SMF indicates to the AMF that the AMF needs to transmit the S1 SM container to the UE, even if the UE is in idle state. If the UP connection of the PDU session is active, the SMF shall also include the N2 resource release request (PDU session ID) in the Namf_Communication_N1N2MessageTransfer, to release the (R)AN resources associated with the PDU session.

The AMF forwards the N1 SM container to the UE via NAS transport message (at step 4c), and if available, the N2 information to the access network (AN). The N1 SM container containing a request to release the PDU session includes the new 5GSM cause value “re-establishment requested with a different S-NSSAI” as described in step 4b. The UE acknowledges the reception of the N1 SM container to the SMF.

After receiving the request in step 4, the UE releases the current or old PDU session, and the UE attempts to establish a new PDU session for the same user traffic (e.g., identified by the same URSP rule) using a different (i.e. alternative)S-NSSAI. As described above, the UE may inspect the URSP rule and identify whether there are one or more RSDs included in the URSP rule. If the UE identifies another RSD (e.g., RSD #2) including another S-NSSAI (e.g., S-NSSAI-2) then the UE initiates the establishment of a PDU session using the RSD #2. If the S-NSSAI-2 is not part of the allowed NSSAI and is not in the rejected NSSAI, then the UE triggers a registration procedure to register with S-NSSAI-2. After the S-NSSAI-2 becomes part of the allowed NSSAI, the UE starts the establishment of a PDU session with S-NSSAI-2.

However, the UE may not be able to determine an alternative S-NSSAI (at step 5) due to conditions, such as (1) there is no RSD with S-NSSAI different from S-NSSAI-1; or (2) the one or more S-NSSAI(s) from the other RSDs of the same URSP rule are in the rejected NSSAI. In this case, the UE determines to initiate the procedure for requesting a registration to an alternative S-NSSAI to S-NSSAI-1 (at step 6), if the UE is configured to use the feature as described in step 1. If the UE has no URSP rules (i.e., no stored or associated S-NSSAI for the established PDU session (e.g., the UE uses the local configuration to establish a PDU session), then the UE uses the local configuration to re-establish the PDU session over an alternative S-NSSAI, if available in the local configuration. If there is no alternative S-NSSAI associated with the user traffic of the current or old PDU session, the UE triggers step 6.

The UE sends a registration request message to the AMF (at step 6), the message including the requested NSSAI parameter (also referred to as an informational element (IE)). The UE includes a new parameter in the requested NSSAI (or new type of requested S-NSSAI indication) that the UE requests a registration to an S-NSSAI which is an alternative to S-NSSAI-1. In other words, the UE requests a registration to a new and unknown S-NSSAI, which should be determined in the network (e.g., by the AMF and/or NSSF), where the new S-NSSAI should be able to serve the data traffic as the replacement to S-NSSAI-1. This new S-NSSAI is not part of the UE configured NSSAI, and the UE may include additional S-NSSAIs in the requested NSSAI, which are part of the configured NSSAI.

Upon reception of the registration request message, including the request for an alternative S-NSSAI (in the requested NSSAI as described in step 6), the AMF (optionally together with NSSF and/or OAM system) determines (at step 7) a S-NSSAI (e.g., S-NSSAI-3) which is supported in the UE current TA. The determined S-NSSAI-3 should beneficially be supported in multiple Tas in order to form a bigger new registration area. If the S-NSSAI-3 is not part of the UE subscribed S-NSSAIs (i.e., is not part of the UE configured NSSAI, then the AMF determines to trigger network slice configuration in the UE by sending a new configured NSSAI to the UE.

The AMF (and/or NSSF) can determine to apply mapping of S-NSSAI-3 to [S-NSSAI-1 in the case of non-roaming, or HPLMN S-NSSAI in case of roaming]. The AMF (and/or NSSF) create a new configured NSSAI and new allowed NSSAI. If the UE is not roaming, the new configured NSSAI includes the S-NSSAI-3 and the mapping of the configured S-NSSAI-3 to the S-NSSAI-1, which is also HPLMN S-NSSAI. If the UE is roaming to a visited public land mobile network (VPLMN) and the S-NSSAI-1 was configured as VPLMN S-NSSAI value mapping to a HPLMN S-NSSAI value (e.g., S-NSSAI-H), then the new configured NSSAI would exchange the S-NSSAI-1 with S-NSSAI-3 in the configured S-NSSAI (and allowed S-NSSAI), and would update the mapping information from “S-NSSAI-1 mapping to S-NSSAI-H” to “S-NSSAI-3 mapping to S-NSSAI-H”.

In one or more implementations, the first network slice can be either the S-NSSAI-1 (which is an S-NSSAI value used in the visited PLMN), or the HPLMN value of the S-NSSAI. In an example for the non-roaming case: (1) Old configured NSSAI: S-NSSAI-1; Mapping of configured NSSAI: none. (2) New configured NSSAI: S-NSSAI-2; Mapping of configured NSSAI: S-NSSAI-2 to S-NSSAI-1. In an example for the roaming case, where S-NSSAI-1 is used in the serving VPLMN and a HPLMN S-NSSAI value is used in the HPLMN, then the AMF replaces the S-NSSAI-1 with a S-NSSAI-2 value. One example of the roaming case for the configured NSSAI (which also applies analogically to the allowed NSSAI) is as follows: (1) Old configured NSSAI: S-NSSAI-1; Mapping of configured NSSAI: S-NSSAI-1 to HPLMN S-NSSAI value. (2) New configured NSSAI: S-NSSAI-2; Mapping of configured NSSAI: S-NSSAI-2 to HPLMN S-NSSAI value.

The AMF sends a registration accept message to the UE (at step 8) including the configured NSSAI (e.g., including S-NSSAI-3 instead of S-NSSAI-1) and the mapping of configured NSSAI (e.g., including mapping of S-NSSAI-3 to S-NSSAI-1, or mapping of S-NSSAI-3 to S.NSSAI-H). Further, a new allowed NSSAI may be included wherein the S-NSSAI-3 is added and S-NSSAI-1 is removed, and corresponding mapping of S-NSSAI-3 to S-NSSAI-1, or mapping of S-NSSAI-3 to S-NSSAI-H is included. If an alternative S-NSSAI cannot be determined and provided to the UE, the AMF sends the S-NSSAI-1 in the reject NSSAI to the UE. The AMF uses an existing cause value for the rejected S-NSSAI-1 (e.g., rejected due to unavailability in the registration area) or a new cause value may be introduced to indicate that the S-NSSAI-1 is rejected temporarily and no alternative S-NSSAI is available. If the UE receives the step 8 mapping information of S-NSSAI-3 to S-NSSAI-1, then the UE triggers a new PDU session establishment to S-NSSAI-3 (at step 9), and in addition, the UE includes the mapping information of S-NSSAI-3 to S-NSSAI-1.

The UE sends a NAS message to the AMF (at step 10), the message including a new PDU session ID (and optionally the association with the old PDU session ID), S-NSSAI-3, mapping of S-NSSAI-3 to S-NSSAI-1, DNN1, and N1 SM container (PDU session establishment request). For SSC mode 3 of the UE, the message also includes the old PDU session ID. The AMF selects a serving SMF for the new PDU session (e.g., SMF3), and the AMF forwards the N1-SM container to the serving SMF (e.g., SMF3). The AMF may use Nsmf_PDUSession_CreateSMContext request service operation to forward the UE request to the SMF3. As the PDU session is established on a new S-NSSAI (S-NSSAI-2), the UE can use a request type “initial request” for a PDU session of SSC mode 1 and 2. For a PDU session of SSC mode 3, the UE can use either request type “initial request” or “existing”, which should not have influence on the AMF operation, as the AMF is supposed to select an SMF in the S-NSSAI-2.

The SMF3 304 proceeds with the establishment of the PDU session by using the S-NSSAI-3 (at step 11). If the mapping information of S-NSSAI-3 to S-NSSAI-1 is provided to the SMF3, and if the SMF3 is in the UE HPLMN (i.e. non-roaming case), the SMF3 uses the mapped S-NSSAI-1 value in the service operation to the UDM to retrieve the UE SM subscription data. The SMF3 does not use the mapped S-NSSAI-1 value as input to select another SMF in the S-NSSAI-1. The SMF3 acts as an anchor SMF for the PDU session. If the SMF3 is in VPLMN for the UE (i.e., roaming case), the SMF3 may determine to use the mapped S-NSSAI value (i.e. S-NSSAI-1) to select and contact an SMF in the HPLMN to establish a home-routed PDU session.

If a PDU session establishment procedure for the roaming scenario applies, the SMF3 would control the intermediate UPF and the SMF1 would serve the anchor UPF (i.e., N9 tunnel is established between the intermediate UPF and the anchor UPF). If the PDU session is to be for local break-out (LBO), the SMF3 uses the mapped S-NSSAI-1 value in the service operation to the UDM to retrieve the UE SM subscription data, and the SMF3 does not use the mapped S-NSSAI-1 value as input to select another SMF in the S-NSSAI-1 in the HPLMN. The SMF2 retrieves the UE session management subscription data from the UDM by invoking the service operation with subscriber data management (SDM), Nudm_SDM_Get request including the parameters subscription permanent identifier (SUPI), session management subscription data, selected DNN, S-NSSAI of the mapped S-NSSAI value (which is the S-NSSAI-1), etc. The S-NSSAI of the mapped S-NSSAI value is also used in the non-roaming scenario.

In an alternative implementation, the AMF may determine (in step 3) to perform a UE configuration update (UCU) procedure, where the AMF (and/or together with NSSF) creates and sends to the UE a new configured NSSAI and allowed NSSAI containing the S-NSSAI-3 and mapping of S-NSSAI-3 to S-NSSAI-1. This alternative may apply in case that the AMF knows that the possible alternative S-NSSAI-3 is not part of the UE subscribed S-NSSAIs. By performing aspects of the described techniques for changing network slices for PDU sessions, a UE determines or finds an alternative S-NSSAI according to the one or more URSP rules. If no alternative S-NSSAI is available in the URSP rule, then a new S-NSSAI is determined in the AMF, after the UE has requested an alternative S-NSSAI from the AMF.

Aspects of the present disclosure include establishment of a new PDU session where an alternative S-NSSAI is applicable. Implementations, a scenario is considered where a UE requests establishment of a new PDU session by using a first S-NSSAI (e.g., S-NSSAI-1). The network (e.g., AMF or NSSF) determines that (1) the S-NSSAI-1 is currently not available (due to congestion, overload, or unfulfilled SLAs) and (2) an alternative second S-NSSAI (S-NSSAI-2) which is part of the UE subscribed S-NSSAIs. It is assumed that the S-NSSAI-2 is not part of the UE allowed NSSAI.

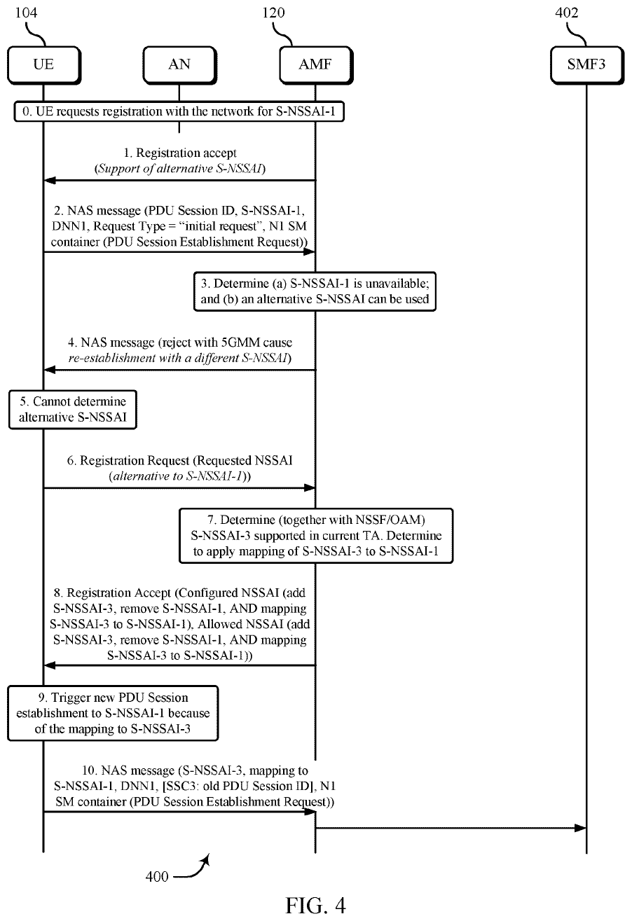

FIG. 4 illustrates an example of a signaling flow diagram 400 that supports techniques for changing network slices for PDU sessions in accordance with aspects of the present disclosure. The example signaling flow diagram 400 illustrates a UE establishing a new PDU session (on a first unavailable S-NSSAI) where the AMF determines to use an alternative second S-NSSAI.

The UE 104 requests registration with the network (at step 0), specifically to register with a first network slice (e.g. S-NSSAI-1). In the NAS registration request message, the UE can indicate to the AMF 120 its capabilities (e.g., core network capability, 5GMM capabilities). The UE include, in addition a new 5GMM capability, whether the UE supports the feature of requesting an alternative S-NSSAI. This UE capability can be used in the AMF to determine whether to provide the UE with a configuration that allows the UE to request an alternative S-NSSAI.

The AMF sends the UE a registration accept message (at step 1), and the message can include a new indication (e.g. configuration) indicating the UE is allowed to request an alternative S-NSSAI. This new indication from the AMF has the meaning of at least one of: (a) the network supports “alternative” S-NSSAI feature and/or (b) the UE is allowed to use the feature of requesting an “alternative” S-NSSAI. The AMF determines whether to send this new indication to the UE based on the UE 5GMM capability received in step 0, UE subscription data (e.g. whether the UE is a subscriber of a certain organization or enterprise), the type of UE subscribed S-NSSAIs, and/or AMF capability and AMF local configuration. If the AMF does not support the feature of alternative S-NSSAI, or the AMF does not allow the UE to use the feature (e.g. a low-priority UE), then the AMF does not send the indication to the UE. If the UE does not receive an indication that UE is allowed to request alternative S-NSSAI, the UE should not initiate step 6.

The UE initiates a new PDU session establishment procedure (at step 2) (e.g., according to the RSD #1 from the example of the UE subscription data and configuration with two network slices, included above). The UE sends a NAS message to the AMF, the message including a new PDU session ID, S-NSSAI-1, DNN1, and N1 SM container (PDU session establishment request).

The AMF determines (at step 3) that the S-NSSAI-1 is unavailable, but that an alternative S-NSSAI can be used to replace S-NSSAI-1. The AMF determines one of the following options. A first option is similar to step 3 described above with reference to FIG. 3, where the AMF invokes the Nsmf_PDUSession_CreateSMContext service operation to request the creation of a new PDU session towards a selected SMF, which serves the S-NSSAI-1, where the AMF includes a new indication to the SMF that the alternative S-NSSAI is supported (as in step 4a described above with reference to FIG. 3). Additionally, the steps 4b through 10 as described above with reference to FIG. 3 can be performed, and the SMF1 would be involved in the procedure, although SMF1 is not used for the final PDU session establishment over the alternative S-NSSAI (e.g., S-NSSAI-3).

In a second option, the AMF determines not to progress the PDU session establishment, and the AMF rejects the request to the UE with an indication that the requested S-NSSAI-1 is not available and an alternative S-NSSAI can be used. For this purpose, an existing 5GMM reject cause (e.g., #69 “Insufficient resources for specific slice”, #69 “Insufficient resources for specific slice and DNN”, or “Payload was not forwarded”) can be used. Additionally, a new 5GMM indication is introduced that the UE can request the N1 SM payload (i.e. PDU session establishment request) over an alternative S-NSSAI. Alternatively, a new 5GMM reject cause can be introduced to trigger the UE to request the NI SM payload for PDU session establishment over an alternative S-NSSAI. The benefit of a new 5GMM reject cause is that the UE would be indicated to trigger registration to an (unknown) alternative S-NSSAI, even if the UE does not have an RSD entry with an S-NSSAI different from S-NSSAI-1. In case of step 3, option b), the AMF sends a NAS message to the UE (at step 4) indicating that the PDU session establishment request is rejected by using one of the alternatives described in step 3, option b). In an implementation, the AMF includes a new 5GMM reject cause, which triggers the UE to request a new PDU session establishment over an alternative, unknown S-NSSAI.

After receiving the NAS message in step 4, the UE releases the current or old PDU session, and the UE attempts to establish a new PDU session for the same user traffic (e.g., identified by the same URSP rule) using a different (i.e. alternative)S-NSSAI. As described above, the UE may inspect the URSP rule and identify whether there are one or more RSDs included in the URSP rule. If the UE identifies another RSD (e.g., RSD #2) including another S-NSSAI (e.g., S-NSSAI-2) then the UE initiates the establishment of a PDU session using the RSD #2. If the S-NSSAI-2 is not part of the allowed NSSAI and is not in the rejected NSSAI, then the UE triggers a registration procedure to register with S-NSSAI-2. After the S-NSSAI-2 becomes part of the allowed NSSAI, the UE starts the establishment of a PDU session with S-NSSAI-2.

However, the UE may not be able to determine an alternative S-NSSAI (at step 5) due to conditions, such as (1) there is no RSD with S-NSSAI different from S-NSSAI-1; or (2) the one or more S-NSSAI(s) from the other RSDs of the same URSP rule are in the rejected NSSAI. In this case, the UE determines to initiate the procedure for requesting a registration to an alternative S-NSSAI to S-NSSAI-1 (at step 6), if the UE is configured to use the feature as described in step 1. If the UE has no URSP rules (i.e., no stored or associated S-NSSAI for the established PDU session (e.g., the UE uses the local configuration to establish a PDU session), then the UE uses the local configuration to re-establish the PDU session over an alternative S-NSSAI, if available in the local configuration. If there is no alternative S-NSSAI associated with the user traffic of the current or old PDU session, the UE triggers step 6.

The UE sends a registration request message to the AMF (at step 6), the message including the requested NSSAI parameter (also referred to as an IE). The UE includes a new parameter in the requested NSSAI (or new type of requested S-NSSAI indication) that the UE requests a registration to an S-NSSAI which is an alternative to S-NSSAI-1. In other words, the UE requests a registration to a new and unknown S-NSSAI, which should be determined in the network (e.g., by the AMF and/or NSSF), where the new S-NSSAI should be able to serve the data traffic as the replacement to S-NSSAI-1. This new S-NSSAI is not part of the UE configured NSSAI, and the UE may include additional S-NSSAIs in the requested NSSAI, which are part of the configured NSSAI.

Upon reception of the registration request message, including the request for an alternative S-NSSAI (in the requested NSSAI as described in step 6), the AMF (optionally together with NSSF and/or OAM system) determines (at step 7) a S-NSSAI (e.g., S-NSSAI-3) which is supported in the UE current TA. The determined S-NSSAI-3 should beneficially be supported in multiple TAs in order to form a bigger new registration area. If the S-NSSAI-3 is not part of the UE subscribed S-NSSAIs (i.e., is not part of the UE configured NSSAI, then the AMF determines to trigger network slice configuration in the UE by sending a new configured NSSAI to the UE.

The AMF (and/or NSSF) can determine to apply mapping of S-NSSAI-3 to [S-NSSAI-1 in the case of non-roaming, or HPLMN S-NSSAI in case of roaming]. The AMF (and/or NSSF) create a new configured NSSAI and new allowed NSSAI. If the UE is not roaming, the new configured NSSAI includes the S-NSSAI-3 and the mapping of the configured S-NSSAI-3 to the S-NSSAI-1, which is also HPLMN S-NSSAI. If the UE is roaming to a VPLMN and the S-NSSAI-1 was configured as VPLMN S-NSSAI value mapping to a HPLMN S-NSSAI value (e.g., S-NSSAI-H), then the new configured NSSAI would exchange the S-NSSAI-1 with S-NSSAI-3 in the configured S-NSSAI (and allowed S-NSSAI), and would update the mapping information from “S-NSSAI-1 mapping to S-NSSAI-H” to “S-NSSAI-3 mapping to S-NSSAI-H”.

In one or more implementations, the first network slice can be either the S-NSSAI-1 (which is an S-NSSAI value used in the visited PLMN), or the HPLMN value of the S-NSSAI. In an example for the non-roaming case: (1) Old configured NSSAI: S-NSSAI-1; Mapping of configured NSSAI: none. (2) New configured NSSAI: S-NSSAI-2; Mapping of configured NSSAI: S-NSSAI-2 to S-NSSAI-1. In an example for the roaming case, where S-NSSAI-1 is used in the serving VPLMN and a HPLMN S-NSSAI value is used in the HPLMN, then the AMF replaces the S-NSSAI-1 with a S-NSSAI-2 value. One example of the roaming case for the configured NSSAI (which also applies analogically to the allowed NSSAI) is as follows: (1) Old configured NSSAI: S-NSSAI-1; Mapping of configured NSSAI: S-NSSAI-1 to HPLMN S-NSSAI value. (2) New configured NSSAI: S-NSSAI-2; Mapping of configured NSSAI: S-NSSAI-2 to HPLMN S-NSSAI value.

The AMF sends a registration accept message to the UE (at step 8) including the configured NSSAI (e.g., including S-NSSAI-3 instead of S-NSSAI-1) and the mapping of configured NSSAI (e.g., including mapping of S-NSSAI-3 to S-NSSAI-1, or mapping of S-NSSAI-3 to S.NSSAI-H). Further, a new allowed NSSAI may be included wherein the S-NSSAI-3 is added and S-NSSAI-1 is removed, and corresponding mapping of S-NSSAI-3 to S-NSSAI-1, or mapping of S-NSSAI-3 to S-NSSAI-H is included. If an alternative S-NSSAI cannot be determined and provided to the UE, the AMF sends the S-NSSAI-1 in the reject NSSAI to the UE. The AMF uses an existing cause value for the rejected S-NSSAI-1 (e.g., rejected due to unavailability in the registration area) or a new cause value may be introduced to indicate that the S-NSSAI-1 is rejected temporarily and no alternative S-NSSAI is available. If the UE receives the step 8 mapping information of S-NSSAI-3 to S-NSSAI-1, then the UE triggers a new PDU session establishment to S-NSSAI-3 (at step 9), and in addition, the UE includes the mapping information of S-NSSAI-3 to S-NSSAI-1.

The UE sends a NAS message to the AMF (at step 10), the message including a new PDU session ID (and optionally the association with the old PDU session ID), S-NSSAI-3, mapping of S-NSSAI-3 to S-NSSAI-1, DNN1, and N1 SM container (PDU session establishment request). For SSC mode 3 of the UE, the message also includes the old PDU session ID. The AMF selects a serving SMF for the new PDU session (e.g., SMF3 402), and the AMF forwards the N1-SM container to the serving SMF (e.g., SMF3). The AMF may use Nsmf_PDUSession_CreateSMContext request service operation to forward the UE request to the SMF3. As the PDU session is established on a new S-NSSAI (S-NSSAI-2), the UE can use a request type “initial request” for a PDU session of SSC mode 1 and 2. For a PDU session of SSC mode 3, the UE can use either request type “initial request” or “existing”, which should not have influence on the AMF operation, as the AMF is supposed to select an SMF in the S-NSSAI-2.

By performing aspects of the described techniques for changing network slices for PDU sessions, the AMF is able to inform the UE about the need to establish the PDU session on an alternative S-NSSAI without requiring the session management (SM) (sub-) layer to be engaged. The UE has the ability to send a new 5GMM capability of requesting a S-NSSAI which is about to replace a current S-NSSAI (e.g., the ability to support the alternative S-NSSAI feature). Additionally, the UE receives configuration information indicating whether to use the feature of an alternative S-NSSAI. The UE receives a new 5GSM indication to re-establish the PDU session on an S-NSSAI which is an alternative to the currently used S-NSSAI (e.g., S-NSSAI-1). The UE determines to request registration to a S-NSSAI alternative to S-NSSAI-1, and sends a request to the AMF to register with an S-NSSAI which is an alternative network slice to S-NSSAI-1.

Further, in aspects of the described techniques for changing network slices for PDU sessions, the AMF has the ability to receive a new UE 5GMM capability of requesting a S-NSSAI which is about to replace a current S-NSSAI (e.g., the ability to support the alternative S-NSSAI feature). Additionally, the AMF sends configuration information to the UE indicating whether to use the feature of an alternative S-NSSAI. The AMF determines that a S-NSSAI-1 is no longer available, but that an alternative S-NSSAI can be used. The AMF sends an indication to the SMF(s) serving the PDU sessions established on S-NSSAI-1 to request release of the PDU session(s), and that an alternative S-NSSAI can be used. The AMF determines to request registration to a S-NSSAI which is an alternative network slice to S-NSSAI-1. The AMF also receives a registration request for S-NSSAI from the UE which is an alternative to the currently used S-NSSAI-1, and determines an alternative S-NSSAI-3. The AMF sends a new configured NSSAI and allowed NSSAI to the UE, including mapping information of S-NSSAI-3 to S-NSSAI-1.

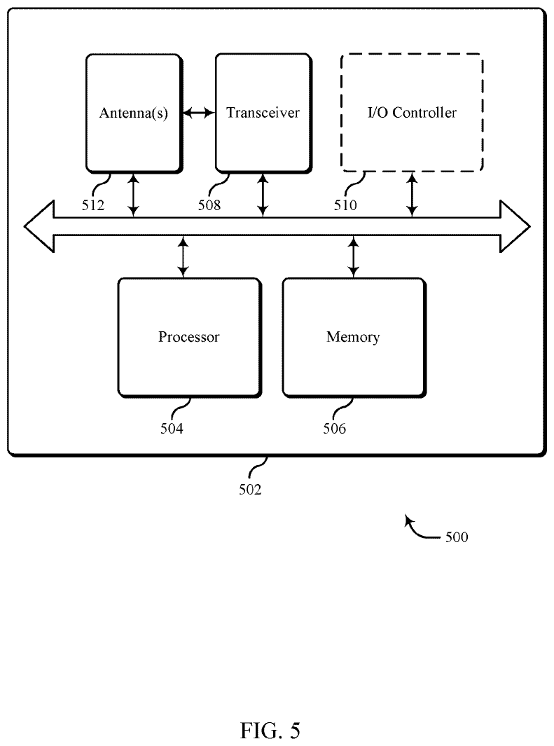

FIG. 5 illustrates an example of a block diagram 500 of a device 502 that supports techniques for changing network slices for PDU sessions in accordance with aspects of the present disclosure. The device 502 may be an example of an AMF (or a network device that implements an AMF) as described herein. The device 502 may support wireless communication with one or more network entities 102, UEs 104, or any combination thereof. The device 502 may include components for bi-directional communications including components for transmitting and receiving communications, such as a processor 504, a memory 506, a transceiver 508, and an I/O controller 510. These components may be in electronic communication or otherwise coupled (e.g., operatively, communicatively, functionally, electronically, electrically) via one or more interfaces (e.g., buses).

The processor 504, the memory 506, the transceiver 508, or various combinations thereof or various components thereof may be examples of means for performing various aspects of the present disclosure as described herein. For example, the processor 504, the memory 506, the transceiver 508, or various combinations or components thereof may support a method for performing one or more of the operations described herein.

In some implementations, the processor 504, the memory 506, the transceiver 508, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 504 and the memory 506 coupled with the processor 504 may be configured to perform one or more of the functions described herein (e.g., executing, by the processor 504, instructions stored in the memory 506).

For example, the processor 504 may support wireless communication at the device 502 in accordance with examples as disclosed herein. The processor 504 may be configured as or otherwise support a means for receiving a first signaling as a registration request from a user equipment (UE) to register with a first network slice; and transmitting a second signaling indicating acceptance of the registration and an allowability of the UE to register with an alternative network slice.

Additionally, the processor 504 may be configured as or otherwise support any one or combination of the alternative network slice is not identified in configured NSSAI. The method further comprising receiving a third signaling from the UE indicating that the UE supports a capability to register with the alternative network slice. The method further comprising transmitting a third signaling to a network function serving a first PDU session that is established on the first network slice, the third signaling including an indication that the first PDU session can be established on an alternative network slice. The method further comprising receiving a third signaling as an additional registration request from the UE to register with the alternative network slice based at least in part on an inability of the UE to identify the alternative network slice in response to the UE having been signaled to re-establish a first protocol data unit (PDU) session. The method further comprising transmitting a fourth signaling to the UE indicating an acceptance of the registration and configured NSSAI including an identity of the alternative network slice, the alternative network slice mapped to the first network slice; and receiving a fifth signaling indicating the UE has established a second PDU session using a same route selection descriptor as the first PDU session based at least in part on the alternative network slice mapped to the first network slice. If the UE is non-roaming, the alternative network slice is mapped to the first network slice based on the NSSAI. If the UE is roaming, the alternative network slice is mapped to the first network slice based on a HPLMN NSSAI.

Additionally, or alternatively, the device 502, in accordance with examples as disclosed herein, may include a processor; and a memory coupled with the processor, the processor configured to receive a first signaling as a registration request from a UE to register with a first network slice; and transmit a second signaling indicating acceptance of the registration and an allowability of the UE to register with an alternative network slice.

Additionally, the wireless communication at the device 502 may include any one or combination of the processor is configured to identify an absence of the alternative network slice in configured NSSAI. The processor is configured to receive a third signaling from the UE indicating that the UE supports a capability to register with the alternative network slice. The processor is configured to transmit a third signaling to a network function serving a first PDU session that is established on the first network slice, the third signaling including an indication that the first PDU session can be established on an alternative network slice. The processor is configured to receive a third signaling as an additional registration request from the UE to register with the alternative network slice based at least in part on an inability of the UE to identify the alternative network slice in response to the UE having been signaled to re-establish a first PDU session. The processor is configured to transmit a fourth signaling to the UE indicating an acceptance of the registration and configured NSSAI including an identity of the alternative network slice, the alternative network slice mapped to the first network slice; and receive a fifth signaling indicating the UE has established a second PDU session using a same route selection descriptor as the first PDU session based at least in part on the alternative network slice mapped to the first network slice.

The processor 504 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 504 may be configured to operate a memory array using a memory controller. In some other implementations, a memory controller may be integrated into the processor 504. The processor 504 may be configured to execute computer-readable instructions stored in a memory (e.g., the memory 506) to cause the device 502 to perform various functions of the present disclosure.

The memory 506 may include random access memory (RAM) and read-only memory (ROM). The memory 506 may store computer-readable, computer-executable code including instructions that, when executed by the processor 504 cause the device 502 to perform various functions described herein. The code may be stored in a non-transitory computer-readable medium such as system memory or another type of memory. In some implementations, the code may not be directly executable by the processor 504 but may cause a computer (e.g., when compiled and executed) to perform functions described herein. In some implementations, the memory 506 may include, among other things, a basic I/O system (BIOS) which may control basic hardware or software operation such as the interaction with peripheral components or devices.

The I/O controller 510 may manage input and output signals for the device 502. The I/O controller 510 may also manage peripherals not integrated into the device M02. In some implementations, the I/O controller 510 may represent a physical connection or port to an external peripheral. In some implementations, the I/O controller 510 may utilize an operating system such as iOS®, ANDROID®, MS-DOS®, MS-WINDOWS®, OS/2®, UNIX®, LINUX®, or another known operating system. In some implementations, the I/O controller 510 may be implemented as part of a processor, such as the processor 504. In some implementations, a user may interact with the device 502 via the I/O controller 510 or via hardware components controlled by the I/O controller 510.

In some implementations, the device 502 may include a single antenna 512. However, in some other implementations, the device 502 may have more than one antenna 512 (i.e., multiple antennas), including multiple antenna panels or antenna arrays, which may be capable of concurrently transmitting or receiving multiple wireless transmissions. The transceiver 508 may communicate bi-directionally, via the one or more antennas 512, wired, or wireless links as described herein. For example, the transceiver 508 may represent a wireless transceiver and may communicate bi-directionally with another wireless transceiver. The transceiver 508 may also include a modem to modulate the packets, to provide the modulated packets to one or more antennas 512 for transmission, and to demodulate packets received from the one or more antennas 512.

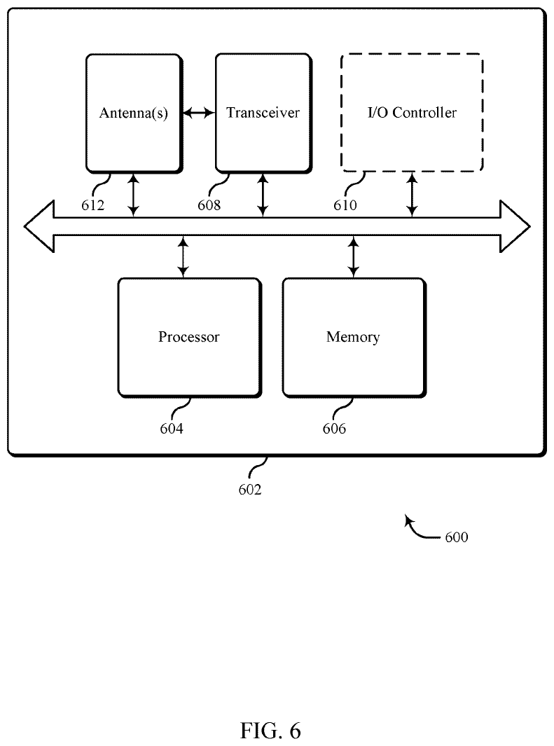

FIG. 6 illustrates an example of a block diagram 600 of a device 602 that supports techniques for changing network slices for PDU sessions in accordance with aspects of the present disclosure. The device 602 may be an example of a UE 104 as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein, and the device may include a processor; and a memory coupled with the processor, the processor configured to transmit a first signaling to request registration with a first network slice; receive a second signaling indicating the registration with the first network slice and an allowability to register with an alternative network slice; and transmit a third signaling to establish a first PDU session on the first network slice.

Additionally, the wireless communication at the device 602 may include any one or combination of the processor is configured to identify an absence of the alternative network slice in configured NSSAI. The processor is configured to transmit a fourth signaling indicating that the apparatus supports a capability to register with the alternative network slice. The processor is configured to receive a fourth signaling indicating to re-establish the first PDU session on the alternative network slice based at least in part on an unavailability of the first network slice; and transmit a fifth signaling to request a registration with the alternative network slice based at least in part on an inability to identify the alternative network slice. The processor is configured to receive a sixth signaling indicating an acceptance of the registration and configured NSSAI including an identity of the alternative network slice, the alternative network slice mapped to the first network slice; and initiate to establish a second PDU session on the alternative network slice, the second PDU session using a same route selection descriptor as the first PDU session based at least in part on the alternative network slice mapped to the first network slice. The processor is configured to transmit the fifth signaling to request the registration with the alternative network slice based at least in part on a determination that there is not an identified alternative network slice for re-establishing the first PDU session.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device M02. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

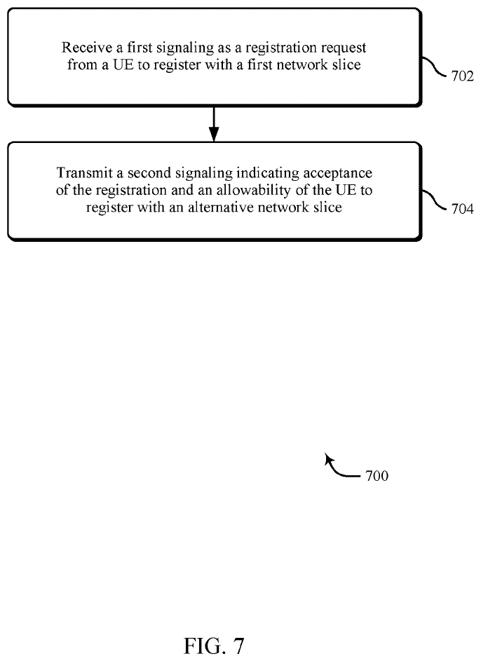

FIG. 7 illustrates a flowchart of a method 700 that supports techniques for changing network slices for PDU sessions in accordance with aspects of the present disclosure. The operations of the method 700 may be implemented by a device or its components as described herein. For example, the operations of the method 700 may be performed by an AMF (or a network device that implements an AMF) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 702, the method may include receiving a first signaling as a registration request from a UE to register with a first network slice. The operations of 702 may be performed in accordance with examples as described herein. In some implementations, aspects of the operations of 702 may be performed by a device as described with reference to FIG. 1.

At 704, the method may include transmitting a second signaling indicating acceptance of the registration and an allowability of the UE to register with an alternative network slice. The operations of 704 may be performed in accordance with examples as described herein. In some implementations, aspects of the operations of 704 may be performed by a device as described with reference to FIG. 1.

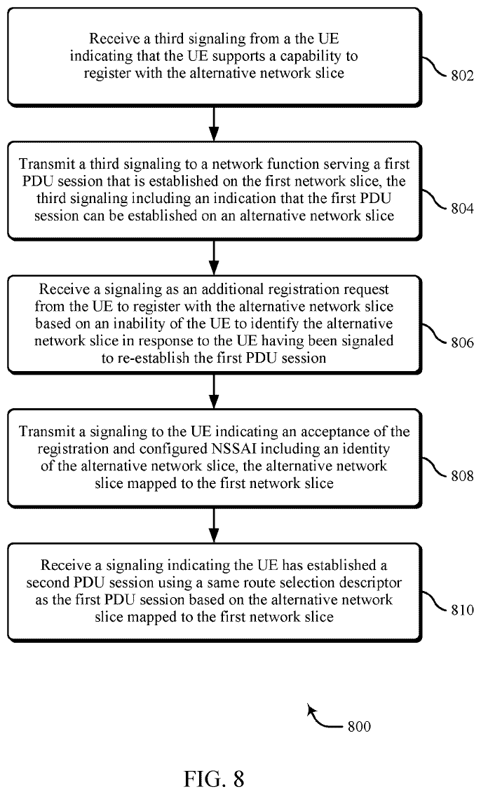

FIG. 8 illustrates a flowchart of a method 800 that supports techniques for changing network slices for PDU sessions in accordance with aspects of the present disclosure. The operations of the method 800 may be implemented by a device or its components as described herein. For example, the operations of the method 800 may be performed by an AMF (or a network device that implements an AMF) as described with reference to FIGS. 1 through 6. In some implementations, the device may execute a set of instructions to control the function elements of the device to perform the described functions. Additionally, or alternatively, the device may perform aspects of the described functions using special-purpose hardware.

At 802, the method may include receiving a third signaling from the UE indicating that the UE supports a capability to register with the alternative network slice. The operations of 802 may be performed in accordance with examples as described herein. In some implementations, aspects of the operations of 802 may be performed by a device as described with reference to FIG. 1.

At 804, the method may include transmitting a third signaling to a network function serving a first PDU session that is established on the first network slice, the third signaling including an indication that the first PDU session can be established on an alternative network slice. The operations of 804 may be performed in accordance with examples as described herein. In some implementations, aspects of the operations of 804 may be performed by a device as described with reference to FIG. 1.

At 806, the method may include receiving a signaling as an additional registration request from the UE to register with the alternative network slice based on an inability of the UE to identify the alternative network slice in response to the UE having been signaled to re-establish the first PDU session. The operations of 806 may be performed in accordance with examples as described herein. In some implementations, aspects of the operations of 806 may be performed by a device as described with reference to FIG. 1.

At 808, the method may include transmitting a signaling to the UE indicating an acceptance of the registration and configured NSSAI including an identity of the alternative network slice, the alternative network slice mapped to the first network slice. The operations of 808 may be performed in accordance with examples as described herein. In some implementations, aspects of the operations of 808 may be performed by a device as described with reference to FIG. 1.

At 810, the method may include receiving a signaling indicating the UE has established a second PDU session using a same route selection descriptor as the first PDU session based on the alternative network slice mapped to the first network slice. The operations of 810 may be performed in accordance with examples as described herein. In some implementations, aspects of the operations of 810 may be performed by a device as described with reference to FIG. 1.

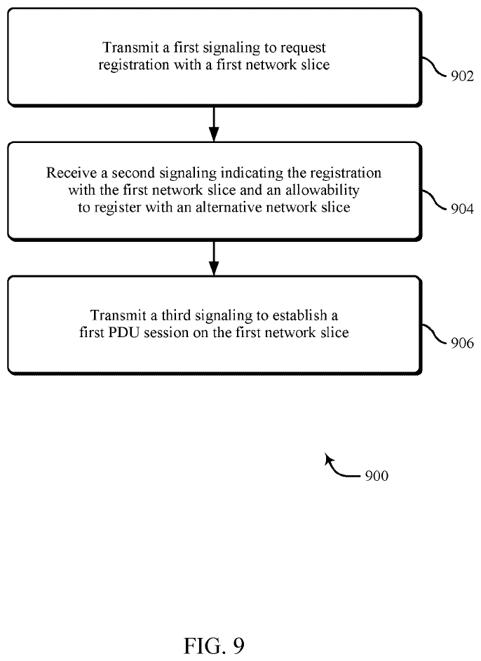

FIG. 9 illustrates a flowchart of a method 900 that supports techniques for changing network slices for PDU sessions in accordance with aspects of the present disclosure. The operations of the method 900 may be implemented by a device or its components as described herein. For example, the operations of the method 900 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 902, the method may include transmitting a first signaling to request registration with a first network slice. The operations of 902 may be performed in accordance with examples as described herein. In some implementations, aspects of the operations of 902 may be performed by a device as described with reference to FIG. 1.

At 904, the method may include receiving a second signaling indicating the registration with the first network slice and an allowability to register with an alternative network slice. The operations of 904 may be performed in accordance with examples as described herein. In some implementations, aspects of the operations of 904 may be performed by a device as described with reference to FIG. 1.

At 906, the method may include transmitting a third signaling to establish a first PDU session on the first network slice. The operations of 906 may be performed in accordance with examples as described herein. In some implementations, aspects of the operations of 906 may be performed by a device as described with reference to FIG. 1.

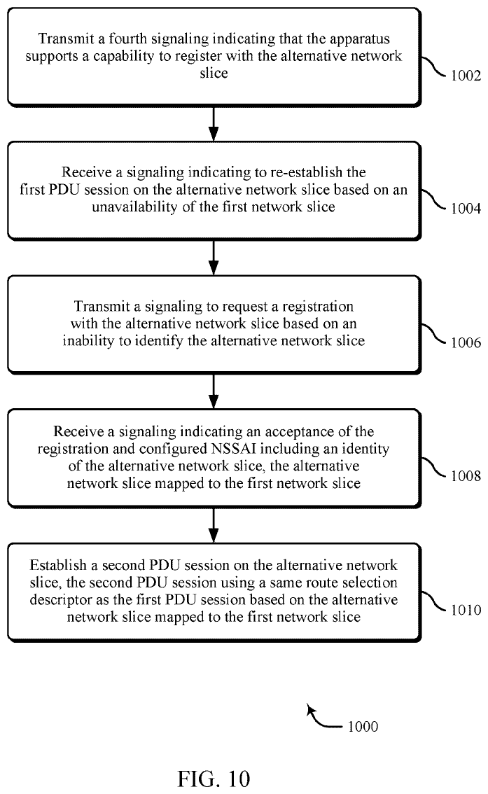

FIG. 10 illustrates a flowchart of a method 1000 that supports techniques for changing network slices for PDU sessions in accordance with aspects of the present disclosure. The operations of the method 1000 may be implemented by a device or its components as described herein. For example, the operations of the method 1000 may be performed by a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1002, the method may include transmitting a fourth signaling indicating that the apparatus supports a capability to register with the alternative network slice. The operations of 1002 may be performed in accordance with examples as described herein. In some implementations, aspects of the operations of 1002 may be performed by a device as described with reference to FIG. 1.

At 1004, the method may include receiving a signaling indicating to re-establish the first PDU session on the alternative network slice based on an unavailability of the first network slice. The operations of 1004 may be performed in accordance with examples as described herein. In some implementations, aspects of the operations of 1004 may be performed by a device as described with reference to FIG. 1.

At 1006, the method may include transmitting a signaling to request a registration with the alternative network slice based on an inability to identify the alternative network slice. The operations of 1006 may be performed in accordance with examples as described herein. In some implementations, aspects of the operations of 1006 may be performed by a device as described with reference to FIG. 1.

At 1008, the method may include receiving a signaling indicating an acceptance of the registration and configured NSSAI including an identity of the alternative network slice, the alternative network slice mapped to the first network slice. The operations of 1008 may be performed in accordance with examples as described herein. In some implementations, aspects of the operations of 1008 may be performed by a device as described with reference to FIG. 1.

At 1010, the method may include establishing a second PDU session on the alternative network slice, the second PDU session using a same route selection descriptor as the first PDU session based on the alternative network slice mapped to the first network slice. The operations of 1010 may be performed in accordance with examples as described herein. In some implementations, aspects of the operations of 1010 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
transmit a first signaling to request a registration with a first network slice;
receive a second signaling indicating the registration with the first network slice and a mapping of an alternative network slice to the first network slice; and
transmit a third signaling to establish a first protocol data unit (PDU) session on the first network slice.

2. The UE of claim 1, wherein the at least one processor is configured to cause the UE to identify an absence of the alternative network slice in configured network slice selection assistance information (NSSAI).

3. The UE of claim 1, wherein the at least one processor is configured to cause the UE to transmit a fourth signaling indicating that the UE supports a capability to register with the alternative network slice.

4. The UE of claim 1, wherein the at least one processor is configured to cause the UE to receive a fourth signaling indicating to re-establish the first PDU session on the alternative network slice.

5. The UE of claim 4, wherein the at least one processor is configured to cause the UE to transmit a fifth signaling to establish a second PDU session including the alternative network slice and the first network slice.

6. The UE of claim 4, wherein the at least one processor is configured to cause the UE to transmit a fifth signaling to request the registration with the alternative network slice based at least in part on a determination that there is not an identified alternative network slice for re-establishing the first PDU session.

7. A network equipment (NE) for wireless communication, comprising:
at least one memory; and
at least one processor coupled with the at least one memory and configured to cause the NE to:
receive a first signaling as a registration request from a user equipment (UE) to register with a first network slice; and
transmit a second signaling indicating acceptance of the registration and a mapping of an alternative network slice to the first network slice.

8. The NE of claim 7, wherein the at least one processor is configured to cause the NE to identify an absence of the alternative network slice in configured network slice selection assistance information (NSSAI).

9. The NE of claim 7, wherein the at least one processor is configured to cause the NE to receive a third signaling from the UE indicating that the UE supports a capability to register with the alternative network slice.

10. The NE of claim 7, wherein the at least one processor is configured to cause the NE to transmit a third signaling to a network function serving a first protocol data unit (PDU) session that is established on the first network slice, the third signaling including an indication that the first PDU session can be established on the alternative network slice.

11. The NE of claim 7, wherein the at least one processor is configured to cause the NE to receive a third signaling as an additional registration request from the UE to register with the alternative network slice based at least in part on an inability of the UE to identify the alternative network slice in response to the UE having been signaled to re-establish a first protocol data unit (PDU) session.

12. The NE of claim 11, wherein the at least one processor is configured to cause the NE to:
transmit a fourth signaling to the UE indicating an acceptance of the registration and configured network slice selection assistance information (NSSAI) including an identity of the alternative network slice, the alternative network slice mapped to the first network slice; and
receive a fifth signaling indicating the UE has established a second PDU session using a same route selection descriptor as the first PDU session based at least in part on the alternative network slice mapped to the first network slice.

13. A method performed by a network equipment (NE), the method comprising:
receiving a first signaling as a registration request from a user equipment (UE) to register with a first network slice; and
transmitting a second signaling indicating acceptance of the registration and a mapping of an alternative network slice to the first network slice.

14. The method of claim 13, wherein the alternative network slice is not identified in configured network slice selection assistance information (NSSAI).

15. The method of claim 13, further comprising:
receiving a third signaling from the UE indicating that the UE supports a capability to register with the alternative network slice.

16. The method of claim 13, further comprising:
transmitting a third signaling to a network function serving a first protocol data unit (PDU) session that is established on the first network slice, the third signaling including an indication that the first PDU session can be established on the alternative network slice.

17-20. (canceled)

21. A method performed by a user equipment (UE), the method comprising:
transmitting a first signaling to request a registration with a first network slice;
receiving a second signaling indicating the registration with the first network slice and a mapping of an alternative network slice to the first network slice; and
transmitting a third signaling to establish a first protocol data unit (PDU) session on the first network slice.

22. The method of claim 21, further comprising:
transmitting a fourth signaling indicating a capability to register with the alternative network slice.

23. The method of claim 21, further comprising:
receiving a fourth signaling indicating to re-establish the first PDU session on the alternative network slice.

24. The method of claim 21, further comprising:
transmitting a fifth signaling to establish a second PDU session including the alternative network slice and the first network slice.
